(19) United States
(12) Patent Application Publication
(10) Pub. No.: US 2024/0380031 A1
(43) Pub. Date: Nov. 14, 2024

(54) BATTERY CELL

(71) Applicant: Volkswagen Aktiengesellschaft, Wolfsburg (DE)

(72) Inventors: Stephan Leonhard KOCH, Koenigslutter (DE); Lukas Kwoczek, Braunschweig (DE)

(73) Assignee: Volkswagen Aktiengesellschaft, Wolfsburg (DE)

(21) Appl. No.: 18/659,826

(22) Filed: May 9, 2024

(30) Foreign Application Priority Data
May 9, 2023 (DE) 10 2023 204 259.2

(51) Int. Cl. H01M 50/103; H01M 50/116; H01M 50/136; H01M 50/15; H01M 50/184; H01M 50/186; H01M 50/264

(52) U.S. Cl. CPC H01M 50/103; H01M 50/116; H01M 50/136; H01M 50/15; H01M 50/184; H01M 50/186; H01M 50/264

(57) ABSTRACT

A battery cell, which includes a cell housing and at least one electrode arrangement. The cell housing having a housing base part and a housing cover. The housing base part, together with the housing cover, limiting an electrode receiving chamber in which the electrode arrangement is arranged. The housing cover is movably connected to the housing base part via a flexible and/or elastic and/or permanently elastic sealing element.

This nonprovisional application claims priority under 35 U.S.C. § 119(a) to German Patent Application No. 10 2023 204 259.2, which was filed in Germany on May 9, 2023, and which is herein incorporated by reference.

### BACKGROUND OF THE INVENTION

### Field of the Invention

The invention relates to a battery cell.

### Description of the Background Art

A generic battery cell includes a completely rigid cell housing, which has a housing base part and a housing cover, which is rigidly connected to the housing base part. The housing base part and the housing cover limit an electrode receiving chamber, in which an electrode stack is arranged. The electrode stack changes its thickness, depending on the state of charge of the battery cell. The rigid cell housing is repeatedly mechanically stressed, i.e., with each charge cycle, due to the change in thickness. The rigid cell housing may withstand this mechanical stress only for a limited number of charge cycles until the cell housing undergoes structural failure.

US 2019/0173065 A1 discloses a hybrid battery cell module. A prismatic battery cell including a pouch battery cell is known from KR 10-1546661 B1. KR 10-0795781 B1 discloses a secondary battery cell and a method for its manufacture.

### SUMMARY OF THE INVENTION

It is therefore an object of the invention to provide a battery cell, whose cell housing is subjected to less mechanical stress with a change in the thickness of the electrode arrangement.

According to an example of the invention, a battery cell is proposed, which includes a cell housing and at least one electrode arrangement, the cell housing including a housing base part and a housing cover, and the housing base part, together with the housing cover, limiting an electrode receiving chamber, in which the electrode arrangement is arranged. According to the invention, the housing cover is movably connected to the housing base part via a preferably flexible and/or elastic and/or permanently elastic sealing element. Due to the flexible connection of the housing cover to the housing base part, the cell housing is subjected to much less mechanical stress—with the same change in thickness of the electrode arrangement—than is the case of the cell housing described at the outset. The cell hosing may therefore withstand many more charge cycles without damage.

The aspects mentioned below primarily relate to the battery cell according to the first example, and the aspects mentioned below may also relate to a battery cell according to further examples.

The housing base part can be trough-shaped and/or dimensionally stable.

The housing base part can include a housing base as well as, preferably exactly four housing side walls.

The housing side walls can each be connected to the housing base and/or are connected to the housing base in a materially uniform manner and/or as a single piece.

Each housing side wall can have a side wall end face.

For example, the housing cover can be designed to be essentially plate-shaped and/or dimensionally stable and/or rigid, and/or the housing base is designed to be essentially plate-shaped and/or dimensionally stable and/or rigid. The use of a rigid plate-shaped housing cover has the advantage that a homogeneous pressure may be easily applied to the electrode arrangement via the housing cover.

The cell housing can be formed by an essentially prismatic, preferably cube-shaped, cell housing.

The housing base part and/or the cell housing can be rotationally symmetrical with respect to a rotational symmetry axis of the cell housing.

The sealing element can be formed by a sealing strip or by a cured and/or cross-linked and/or permanently elastic sealing material. The sealing material particularly preferably has the advantage that manufacturing tolerances between the housing base part and the housing cover may be easily compensated for. In the case of minor thickness changes, in particular, the permanently elastic sealing material may be particularly advantageously used. In the case of greater thickness changes, the sealing strip has advantages compared to the sealing material.

For example, the sealing element or the sealing strip or the cured and/or cross-linked and/or permanently elastic sealing material may each have the shape of a closed ring.

The electrode arrangement can be in direct contact connection with a cover surface of the housing cover on the inside of the housing and/or with the housing base, preferably in each state of charge of the electrode arrangement.

The housing cover can extend in parallel to the housing base, preferably in each state of charge of the electrode arrangement.

An annular gap, which runs in the circumferential direction with respect to a rotational symmetry axis of the housing base part or with respect to a rotational symmetry axis of the cell housing, can extend between the housing cover and the housing side walls of the housing base part. It may preferably be provided that the sealing element is arranged in the annular gap and extends along the entire annular gap, preferably without interruption. The annular gap has the advantage that no narrow manufacturing tolerances need to be maintained between the housing cover and the housing base part.

The sealing element can be connected to the cover surface of the housing cover on the inside of the housing and/or to the narrow end surfaces of the housing cover.

The sealing element can be partially or completed connected to inner surfaces of the housing side walls and/or to the side wall end faces of the housing side walls.

The sealing element can seal the electrode receiving chamber to the outside, preferably gas-tight, preferably in the region of the annular gap. The electrode receiving chamber is thus reliably sealed against the penetration of, for example, moisture or dirt.

The housing cover may at least partially projects over the housing base part when the electrode arrangement is approximately fully charged or fully charged. Further, it may be provided that the housing cover can close upwardly flush with the side wall end faces of the housing base part when the electrode arrangement is approximately fully charged or fully charged. The housing cover can extend completely on the side of an end face plane facing the housing base when the electrode arrangement is approximately fully charged or fully charged. For example, the side wall end faces can extend in the end face plane, for example, outside of recesses.

The sealing element can bulge and/or press outwardly over the housing base part, preferably radially to the outside, preferably with respect to a rotational symmetry axis of the housing base part and/or to the greatest extent, and/or the housing cover can extend completely on the side of an end face plane facing the housing base when the electrode arrangement is approximately fully discharged or fully discharged, and/or the sealing element can be connected to the housing base part and the housing cover in such a way that the sealing element is in a stretched state, preferably in the direction of the housing base, when the electrode arrangement is at least approximately discharged. Due to the fact that the sealing element bulges and/or presses radially to the outside, the displacement of the sealing element into the electrode receiving chamber may be prevented. A mechanical damage of the electrode stack by the sealing element may be prevented thereby.

Also, in the region of the side wall end faces, the housing side walls may limit groove-shaped and/or cuboid recesses, into which the sealing element may be displaced, preferably when the electrode arrangement is approximately fully charged or fully charged. The sealing element may thus not only press or bulge radially to the outside, but also simultaneously be displaced into the region of the recesses. This ensures with a particularly high degree of certainty that the electrode stack may not be damaged by the sealing element.

The sealing element can be connected to the housing base part and the housing cover in such a way that the sealing element is in an unstretched and/or compressed state when the electrode arrangement is approximately fully charged or fully charged.

The battery cell can changes its thickness when the state of charge of the electrode arrangement changes. This may also be referred to as “breathing.”

A housing base part depth of the housing base part and/or the electrode stack is dimensioned in such a way that the housing cover projects over the housing base part by a projection when the battery cell is approximately fully charged or fully charged, and/or the housing cover does not project out of the housing base part when the battery cell is approximately fully charged or fully charged. The recesses may be optionally provided in both cases.

According to the invention, an arrangement is proposed, which includes a first battery cell according to the first example and a second battery cell according to the first example, the housing base of the first battery cell and the housing base of the second battery cell being arranged congruently to each other, and the housing base of the first battery cell and the housing base of the second battery cell being connected to each other, preferably in a materially uniform manner and/or as a single piece and/or over a wide area. Two battery cells may thus be easily combined with each other in a space-saving manner.

It may be provided, for example, that the housing cover, the cover surface has the cover surface on the inside of the housing, a cover surface on the outside of the housing, and preferably exactly four narrow side surfaces.

According to the invention, a battery cell is proposed, which includes a cell housing and at least one electrode arrangement, preferably as described above, the cell housing including a housing base part, preferably as described above, as well as a housing cover, and the housing base part, together with the housing cover, limiting an electrode receiving chamber, for example, as described above, in which the electrode arrangement is arranged. According to the invention, the housing cover is formed by a preferably non-rigid and/or flexible and/or pouch foil-like foil. Due to the fact that the housing cover is provided with a non-rigid and/or flexible design, the mechanical stresses occurring during the charge cycles are absorbed by the expansion of the foil. A structural failure of the cell housing may thus be avoided.

It may be provided, for example, that the material of the housing base part can be entirely or partially plastic, preferably fiber-reinforced plastic, and/or the material of the housing base part can be entirely or partially metal, and/or the material of the housing base part includes metal and preferably fiber-reinforced plastic.

It may be provided by way of example that the housing base part can include a housing base and preferably exactly four housing side walls, each having an outer surface, and the foil is fastened directly or indirectly with an intermediate layer of a plastic coating to one, two, three, or all outer surfaces of the housing side walls, preferably glued or sealed to one, two, three, or all outer surfaces of the housing side walls.

According to the invention, an arrangement can be provided, which includes a first battery cell according to the second example and a second battery cell according to the second example, the housing base of the first battery cell and the housing base of the second battery cell being arranged congruently to each other, and the housing base of the first battery cell and the housing base of the second battery cell being connected to each other, preferably in a materially uniform manner and/or as a single piece and/or over a wide area. Two battery cells may thus be easily combined with each other in a space-saving manner.

The foil of the first battery cell and the foil of the second battery cell can be connected in a materially uniform manner and/or as a single piece.

The foil of the first battery cell and the foil of the second battery cell can be fastened to one and the same outer surface of one of the housing side walls and/or are glued to one and the same outer surface of one of the housing side walls.

The housing base of the first battery cell and the housing base of the second battery cells can each project over the housing side walls radially to the outside, preferably in an annular manner, preferably with respect to a rotational symmetry axis of the cell housing, forming an annular projection, and the annular projection is not covered by the foil(s) and/or not by the plastic coating.

The aspects mentioned below also relate to the battery cell according to the first example as well as to the battery cell according to the second example.

It may be provided, for example, that the electrode arrangement can include at least two preferably plate-shaped or cuboid electrodes and one preferably plate-shaped separator.

It may be provided by way of example that the electrodes and the separator can be stacked one on top of the other along the rotational symmetry axis of the cell housing, it preferably being able to be provided that the separator is arranged between the electrodes, and/or the electrodes are separated by the separator, preferably electrically and/or electrochemically.

An electrode arrangement which is formed by multiple electrodes stacked one on top of the other along the rotational symmetry axis of the cell housing may be referred to as an electrode stack.

The electrodes and the separator can be wound around a common winding axis, it being preferably able to be provided that the two electrodes are separated by the separator, preferably electrically and/or electrochemically.

The housing base part and/or the cell housing can be rotationally symmetrical, preferably in a two-fold or four-fold manner, with respect to the rotational symmetry axis of the cell housing, it preferably being able to be provided that the rotational symmetry axis extends orthogonally to the housing base.

The housing base part can be a component manufactured in a materially uniform and/or one-piece and/or integral manner. It may alternatively be provided that the housing base is joined to the housing side walls.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional side view of a battery cell according to a first example, including a cell housing and an electrode arrangement in an uncharged state;

FIG. 2 shows a sectional side view of the arrangement according to FIG. 1, including the cell housing and the electrode arrangement in a charged state;

FIG. 3 shows a side view of a housing side wall of the cell housing according to FIG. 1;

FIG. 4 shows a sectional side view of an arrangement, which includes two battery cells according to the first example;

FIG. 5 shows a sectional side view of a battery cell according to a second example, including a cell housing and an electrode arrangement in a partially charged state; and

FIG. 6 shows a sectional side view of an arrangement, which includes two battery cells according to the second example.

### DETAILED DESCRIPTION

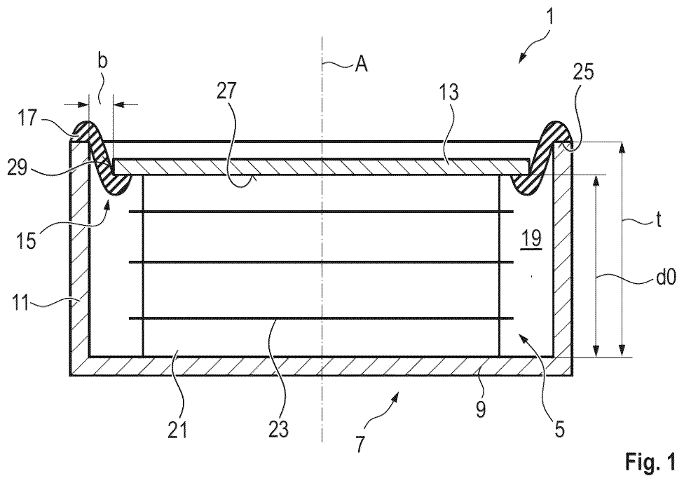

A battery cell 1 according to a first example is shown in FIG. 1, which includes a cell housing and a cuboid electrode arrangement 5. The cell housing includes a trough-shaped, rigid housing base part 7 having a housing base 9 and four housing side walls 11 as well as a rigid and plate-shaped housing cover 13.

An annular gap 15 having an annular gap width b extends between housing cover 13 and housing side walls 11. A sealing element 17 formed by a cured and/or cross-linked and/or permanently elastic sealing material extends in annular gap 15, with the aid of which housing cover 13 is flexibly and/or movable connected to housing base part 7 in such a way that housing cover 13 is essentially displaceable in parallel to housing base 9.

Housing base part 7, housing cover 13, and sealing element 17 together limit an electrode receiving chamber 19, in which electrode arrangement 5 is arranged. Electrode arrangement 5 is formed by electrodes 21 and separators 23, one of separators 23 being arranged in each case between two adjacent electrodes 21. Housing base part 7 and the cell housing are each rotationally symmetrical, preferably in a two-fold or four-fold manner, with respect to a rotational symmetry axis A.

Sealing element 17 is connected to housing side walls 11 in the region of side wall end faces 25 of housing side walls 11. Sealing element 17 is additionally connected to a cover surface 27 of housing cover 13 on the inside of the housing and to narrow side surfaces 29 of housing cover 13.

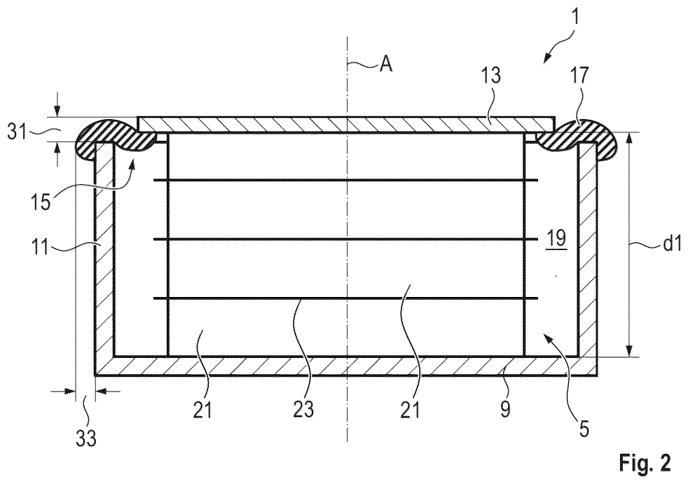

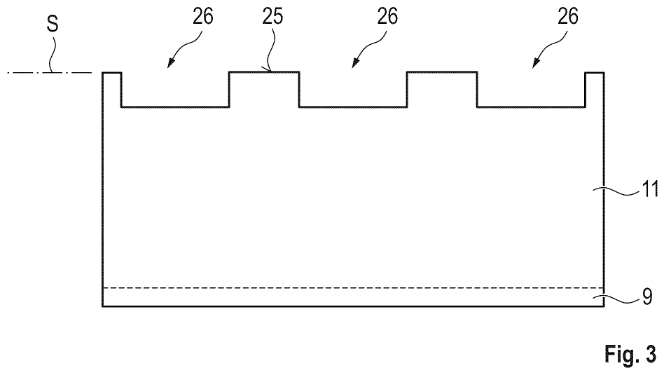

Sealing element 17 seals electrode receiving chamber 19 gas-tight to the outside and, due to the flexible connection of housing cover 13 to housing base part 7, permits a height of electrode receiving chamber 19 to be adapted to a stack thickness of electrode arrangement 5, which increases as the state of charge of electrode arrangement 5 increases. Electrode arrangement 5 has its maximum stack thickness d1 when the battery cell is fully charged. At the same time, electrode receiving chamber 19 has its maximum height. This state of charge is illustrated, for example, in FIG. 2. Electrode arrangement 5 has its minimum stack thickness d0 when the battery cell is discharged. At the same time, electrode receiving chamber 19 has its minimum height. This state of charge is illustrated, for example, in FIG. 1, housing cover 13 extending on the side of an end face plane S (cf. FIG. 3), which faces housing base 9. Side wall end faces 25 extend into end face plane S outside recesses 26 (cf. FIG. 3).

A housing base part depth t (cf. FIG. 1) of housing base part 7 is dimensioned in such a way that housing cover 13 projects out of housing base part 7 with a projection 31 when battery cell 1 is fully charged, as illustrated in FIG. 2. Sealing element 17 is dimensioned and connected to housing cover 13 and to housing base part 7 in the manner described in such a way that sealing element 17 is at least partially displaced radially to the outside over housing base part 7 by a radial projection 33 with respect to a rotational symmetry axis A in the approximately fully charged or fully charged state of charge of battery cell 1, as illustrated in FIG. 2. When battery cell 1 is fully charged housing cover 13 is arranged completely between side wall end faces 25 and housing base 9 with respect to rotational symmetry axis A, as illustrated in FIG. 1.

A side view of housing side walls 11 is illustrated in FIG. 3. Housing side wall 11, specifically side wall end face 25, limits recesses 26, into which sealing element 17 is at least partially displaced in the approximately fully charge or fully charged state of electrode arrangement 5.

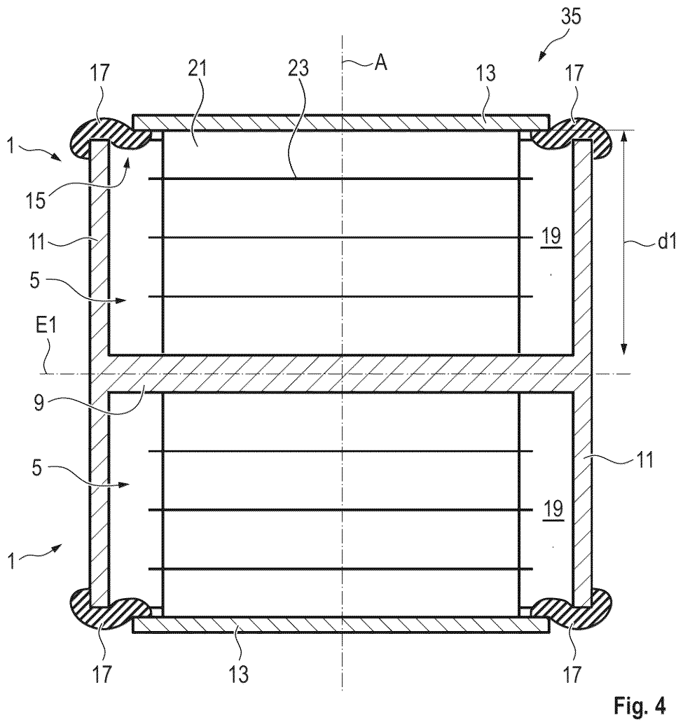

An arrangement 35 is illustrated in FIG. 4, which includes two identical battery cells 1. Housing base 9 of battery cells 1 are connected to each other in a materially uniform manner and as a single piece in such a way that housing side walls 11 of battery cells 1 line up with each other axially with respect to rotational symmetry axis A. Battery cells 1 are plane-symmetrical to a first symmetry plane E1, which extends between housing bases 9 of battery cells 1.

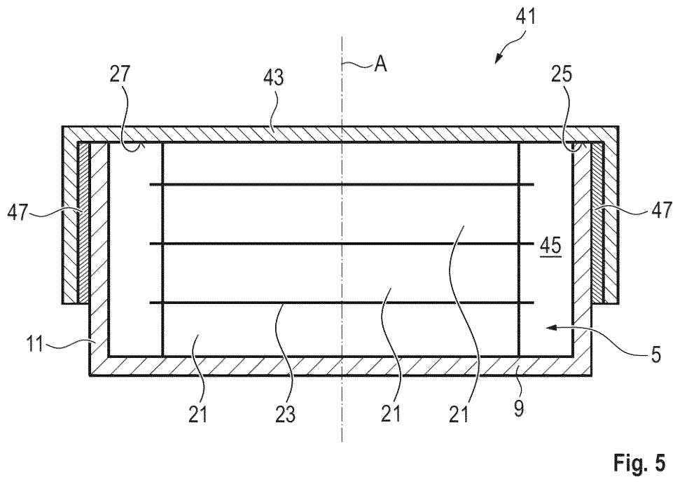

A battery cell 41 according to a second example is illustrated in FIG. 5. Components which have the same structure and/or the same behavior and/or the same function as already described in connection with the first example are designated by the same reference numerals in connection with the first example and in connection with the second example. In this regard, reference is made to the detailed descriptions in connection with the first example.

Battery cell 41 includes housing base part 7 as well as electrode arrangement 5. Housing base part 7, together with a housing cover 43, limits an electrode receiving chamber 45.

In comparison to the first example, housing cover 43 in the case of this battery cell 41 is formed by a preferably non-rigid and/or flexible and/or pouch foil-like foil.

Housing base part 7 is manufactured from metal and is provided with a plastic coating 47 on outer surfaces of housing side walls 11, to which housing cover 43 formed by the foil is glued.

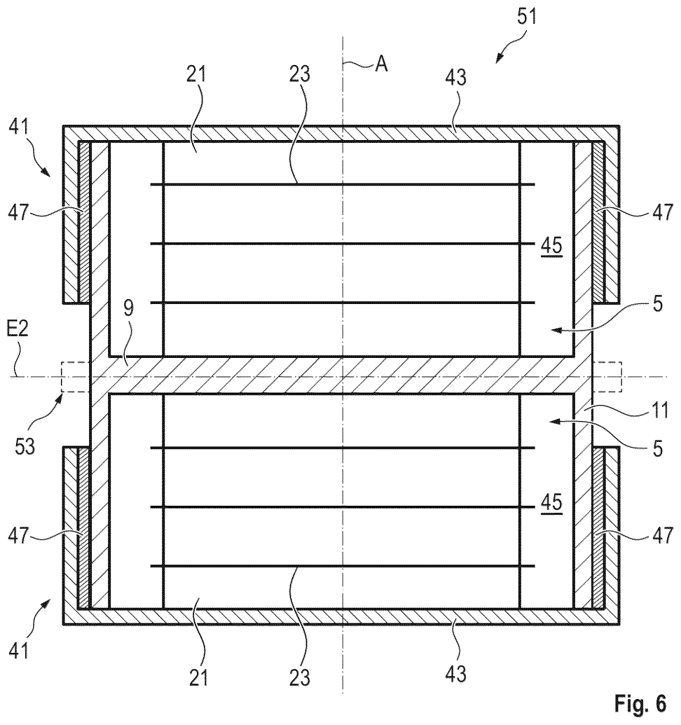

An arrangement 51 is illustrated in FIG. 6, which includes two identical battery cells 41. Housing bases 9 of battery cells 41 are connected to each other in a materially uniform manner and as a single piece in such a way that housing side walls 11 of battery cells 41 line up with each other axially with respect to rotational symmetry axis A. Battery cells 41 are plane-symmetrical to a second symmetry plane E2, which extends between housing bases 9 of battery cells 41.

As illustrated in FIG. 6, an annular projection 53 (shown by the dashed lines), which projects radially to the outside, may be provided in arrangement 51 in the region of housing bases 9, which is not covered by either the foil or by plastic coating 47. Arrangement 51 may be particularly efficiently connected to a cooling system of battery cells 41 via this annular projection 53.

The foils of the two battery cells 41 may be connected to each other in a materially uniform manner and/or as a single piece, and they may both be glued to a plastic coating 47 applied to an outer surface of housing side walls 11.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery cell comprising:
a cell housing having a housing base part and a housing cover; and
at least one electrode arrangement,
wherein the housing base part, together with the housing cover, limits an electrode receiving chamber in which the electrode arrangement is arranged, and
wherein the housing cover is movably connected to the housing base part via a flexible and/or elastic and/or permanently elastic sealing element.

2. The battery cell according to claim 1, wherein the sealing element is formed by a sealing strip or by a cured and/or cross-linked and/or permanently elastic sealing material.

3. The battery cell according to claim 1, further comprising an annular gap that runs in a circumferential direction with respect to a rotational symmetry axis of the housing base part or the cell housing, extends between the housing cover and housing side walls of the housing base part, wherein the sealing element is arranged in the annular gap and extends along the entire annular gap without interruption.

4. The battery cell according to claim 3, wherein the sealing element seals the electrode receiving chamber to an outside gas-tight area in a region of the annular gap.

5. The battery cell according to claim 1, wherein the housing cover at least partially projects over the housing base part when the electrode arrangement is approximately fully charged or fully charged, and/or the sealing element bulges and/or presses outwardly over the housing base part radially to the outside or with respect to a the rotational symmetry axis of the housing base part and/or to a greatest extent, and/or the housing cover extends completely on a side of an end face plane facing the housing base when the electrode arrangement is approximately or fully discharged, and/or the sealing element is connected to the housing base part and the housing cover such that the sealing element is in a stretched state in a direction of the housing base when the electrode arrangement is at least approximately discharged.

6. An arrangement comprising a first battery cell and a second battery cell, the first and second battery cell being the battery cell according to claim 1, a housing base of the first battery cell and a housing base of the second battery cell being arranged congruently to each other, and the housing base of the first battery cell and the housing base of the second battery cell being connected to each other in a materially uniform manner and/or as a single piece and/or over a wide area.

7. A battery cell comprising:
a cell housing; and
at least one electrode arrangement,
wherein the cell housing has a housing base part as well as a housing cover,
wherein the housing base part, together with the housing cover, limits an electrode receiving chamber in which the electrode arrangement is arranged, and
wherein the housing cover is formed by a non-rigid and/or flexible and/or elastic and/or pouch foil-like foil.

8. The battery cell according to claim 7, wherein a material of the housing base part is entirely or partially plastic or fiber-reinforced plastic, and/or wherein the material of the housing base part is entirely or partially metal, and/or wherein the material of the housing base part includes metal and fiber-reinforced plastic.

9. The battery cell according to claim 7, wherein the housing base part includes a housing base and exactly four housing side walls, each having an outer surface, and wherein the foil is fastened directly or indirectly with an intermediate layer of a plastic coating to one, two, three, or all outer surfaces of the housing side walls by being glued or sealed to one, two, three, or all outer surfaces of the housing side walls.

10. An arrangement comprising a first battery cell and a second battery cell, the battery cell of the first and second battery cell being the battery cell according to claim 7, wherein a housing base of the first battery cell and a housing base of the second battery cell are arranged congruently to each other, and wherein the housing base of the first battery cell and the housing base of the second battery cell are connected to each other in a materially uniform manner and/or as a single piece and/or over a wide area.
